(19) United States
(12) Patent Application Publication
(10) Pub. No.: US 2023/0022044 A1
(43) Pub. Date: Jan. 26, 2023

(54) ANALYSIS DEVICE, AND METHOD FOR DETECTING MALWARE IN AN iOS DEVICE

(71) Applicant: Certo Software Limited, Basingstoke (GB)

(72) Inventors: Simon Lewis, Basingstoke (GB); Russell Kent-Payne, Basingstoke (GB)

(21) Appl. No.: 17/381,524

(22) Filed: Jul. 21, 2021

(51) Int. Cl. G06F 21/56

(52) U.S. Cl. CPC G06F 21/565; G06F 21/566; G06F 21/564; G06F 2221/034

(57) ABSTRACT

A method for detection of malware being installed in an Internet Operating System (iOS) device comprises: identifying at least one known malware signature that is indicative of malware being installed on the iOS device; obtaining a backup of the iOS device that contains a plurality of data files; scanning the plurality of data files of the backup of the iOS device; comparing the scanned plurality of backup data files with at least one known malware signature that is indicative of malware being installed on the iOS device; and identifying malware as being installed on the iOS device, in response to a match of the at least one of the plurality of scanned backup data files with the at least one known malware signature.

### FIELD OF THE INVENTION

The field of the invention relates to cyber security and malware threat detection. The invention is applicable to, but not limited to, an analysis device, and a method for detection of malware in, say, an Internet Operating System (iOS) cell phone device via a backup of the iOS device.

### BACKGROUND OF THE INVENTION

Malware is typically defined as any software intentionally designed to cause damage or facilitate unauthorised access to a computer, server, client, computer network, or a mobile communication or gaming device. A wide variety of malware types exist, including computer viruses, worms, Trojan horses, ransomware, spyware, adware, rogue software, wiper and scareware. Hence, security applications have been created with the capability of scanning a potentially ‘infected’ device for malware as well as other threats. Software applications for Windows™, Mac™, and Android™ operating systems (OS) generally have the ability to access areas of the device's file system where malware typically resides, thus allowing effective detection of malware on these operating systems.

On devices that run the Apple™, iOS™ operating system, iOS™ security apps offer basic security functionality, such as an iOS™ version check, WiFi™ security check or a virtual private network (VPN) service. iOS™ software applications are ‘sandboxed’ and therefore cannot access areas of the device's file system outside of the application's own ‘container’.

Consequently, iOS™ security apps are unable to scan the device for malware, which is typically/always located outside of a particular application's container. Furthermore, IOS™ security apps do not have the ability to scan the iOS™ file system for threats. Therefore, iOS™ device owners currently have no way to see if malware (e.g., spyware) has been installed on their devices. Therefore, whilst these iOS™ apps may be referred to as a ‘security app’ on an iOS™ device, they are unable to actually check for malware, since malware would be configured to reside in areas of the device's file system that cannot be accessed by the security application. Hence, an iOS™ device cannot effectively be scanned for malware.

In contrast, for the wholly different platform of Android devices, anti-malware security applications do have the ability to scan the device for malware, since software applications on Android devices have a lot more freedom in terms of how they can access wide areas of the file system as well as data from other applications.

In this technical field, ‘areas’ may be defined as system files or files from other applications that are intended to be private, and therefore should not be accessible by other apps. In this technical field, the term ‘sandboxed’ means that the apps can only read/write data in their own container. By default, all iOS apps are in a ‘sandbox’. In this technical field, the term ‘container’ encompasses any data store (akin to a folder) that is accessible and used by an application to perform its function. Each app has its own container that should be private to that app. For example, a game app will only have access to data in its own container (e.g., high score, lives remaining, etc). Since it is sandboxed, it would not have access to the WhatsApp™ container, as doing so would allow it to read private messages from that app.

Furthermore, iOS™ was designed to only allow Apple-approved apps to be installed on the device. This means that installing malware on an iOS is more difficult than on other platforms that do not have the same restrictions. However, it is known that there are ways around this restriction, for example by using exploits to remove the sandbox restriction or by sideloading unapproved malicious apps. This means that whilst iOS™ is more difficult to infect with malware, it is not impossible.

As such, many commercial spyware applications (‘apps’) exist that can be installed on an iOS™ device in order to monitor the device's activity, often without the owner's permission. These apps can also be hidden, so that the owner is unaware that the user's activities and the device itself are being monitored.

It is known that computer systems are able to retrieve contents of an iOS™ file system via a backup procedure, either directly over a wired connection, or local wireless connection or by downloading from Apple™'s cloud services (iCloud™). Once the content of the iOS™ device's file system is stored on a computer it can be searched by software applications located on the computer system.

Thus, a mechanism is desired in order to determine whether malware exists on an iOS™ device.

### SUMMARY OF THE INVENTION

The present invention provides an analysis device, and a method for detection of malware via a backup of the iOS™ device, as described in the accompanying claims. Specific embodiments of the invention are set forth in the dependent claims. These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1a and FIG. 1b illustrate one example of a flowchart of a method for detection of malware via a backup of the iOS™ device, according to a first example embodiment of the invention.

FIG. 2 illustrates one example of a flowchart of a method for detection of malware via a backup of the iOS™ device, according to a second example embodiment of the invention.

FIG. 3a and FIG. 3b illustrate one example of a flowchart of a method for detection of malware via a backup of the iOS™ device, according to a third example embodiment of the invention.

FIG. 4 illustrates a first example of an analysis device for connecting to an iOS™ device and configured to detect malware via a backup of the iOS™ device, according to the first or second example embodiments of the invention.

FIG. 5 illustrates a second example of an analysis device configured to detect malware via a backup of the iOS™ device, according to the third example embodiment of the invention.

### DETAILED DESCRIPTION

Examples of the invention are described with reference to an analysis device, and a method for detection of malware in an Internet Operating System (iOS) device, such as, say, an iOS™ cell phone device via a backup of the iOS™ device. However, it is envisaged that other examples of the invention are equally applicable to an iPad™, noting that iPad™s historically ran iOS™, but now run iPadOS™, as the malware detection concepts herein described can be applied to either device.

Examples of the invention are also described with reference to identifying any indicator of malware, hereinafter referred to as identifying a ‘malware signature’. It is envisaged that the term ‘malware signature’ encompasses a ‘malware file’ that triggers a detection, as well as, for example, a certain keyword within a legitimate file or a configuration setting that triggers a detection.

Through extensive research, the inventors have identified several files (referred to herein as ‘key files’) residing within the IOS™ file system that are created or modified when malware is installed on an iOS™ device. Therefore, in some examples, and following the obtaining of a backup of the files of the iOS™ device and device configuration settings, these files and settings can be searched to determine if malware has been installed on the iOS™ device. In some examples, a large database (referred to hereafter as a ‘threat database’) of malware signatures can be created and used when searching the key files from the iOS™ file system, in order to determine the type of malware that is installed, if any.

In some examples, a mechanism for identifying such key files and their modification may encompass the following: create a backup of a ‘clean’ device, e.g., iPhone™; infect the device with known malware; create a backup of the ‘infected’ device; compare the contents of the respective backups and use digital forensic techniques to identify key files and malware signatures. This process would then be repeated as the key files created/modified by each type of malware can vary, so the process would be repeated for each different malware, to find the specific key files or signatures for each. In some examples, it is envisaged that the process may include periodically revisiting some malware and running the process again as new versions of the same malware may have subtle changes that enable new signatures to be detected for that malware. To clarify, there are hundreds of types of malware for iOS™. For a number and in some examples for each one, it is envisaged that the process would be repeatedly performed in order to find associated key files and signatures. In some examples, it is envisaged that the iOS™ device may be wiped clean, before moving on to the next malware to ensure there are no malware or signature remnants and the malware detection process for a particular identified malware, starts with a ‘clean slate’.

In a context of some examples of the invention, a clean device encompasses a device that has been reset to a new or factory condition and therefore only contains it's default file system and no additional files. Using a clean device as a starting point, when identifying malware, provides a number of benefits. First, there is a lower number of files to analyse when identifying malware. Secondly, it prevents remnants of malware from previous tests still residing on the iOS™ device and ensures that any malware signatures that are found are definitely related to the specific malware that signatures have been created to detect.

In accordance with examples of the invention, the expression ‘digital forensic techniques’ for identifying key files and malware signatures encompasses at least examining the data from a digital storage device in a forensically sound manner with the aim of recovering, preserving and analysing the data, in order to prove existence of malware and define signatures that can be used to facilitate identification of said malware. More specifically, some of the techniques employed may include: file hash analysis, line-by-line comparison of modified files, keyword searches, metadata analysis and file path review.

In accordance with some examples of the invention, malware detection may encompass searching for certain key files, and then searching each of these for malware signatures that have been listed in a threat database.

In some examples, the malware detection may encompass checking a device settings file in order to determine whether the iOS™ device is configured to synchronise its contents with a local computer, say over WiFi™, as this configuration setting may be an indicator of certain types of iOS™ spyware. In some examples, this approach may involve looking for a TRUE/FALSE flag in a specific settings file.

Thereafter, in some examples, the malware detection may encompass checking a device settings file for custom keyboards on the device. For example, a custom keyboard may indicate that a keylogger is on the iOS™ device. In some examples, checking for such malware that may exhibit itself as a keylogger may be performed by searching for a signature in a specific file and retrieving a list of all non-standard (custom) keyboards on the iOS™ device. This may involve comparing the settings (e.g., keyboard or app name) against the threat database to determine whether it has previously been marked as definitely malicious.

In some examples, checking for malware may involve checking a device settings file for unofficial apps (e.g., Enterprise/Developer apps), which could be malicious. To do this an analysis of a specific database file may be made from a backup of the iOS™ device, and a list of unofficial apps present on the device extracted. Again, this may involve comparing the settings (e.g., app name or developer name) against the threat database to determine whether it has previously been marked as definitely malicious. In some examples, checking for such malware may involve other checks that may be added to the software in the future that work in a similar way, e.g., read settings for specific files from the iOS™ backup such that a decision may be made if that setting indicates malware.

Thus, in some examples, the malware may be detectable as a specific setting, e.g., a device configuration setting, in a specific file (as listed in the key files), but where analysing a specific file within the iOS backup does not make use of the threat database in the same manner as previously described.

Some examples of the invention are described with reference to comparing a source file path, which in some examples may include a path and a filename (for example: “C:/Users/Bob/Desktop/document.pdf” would be an example of a source file path), with a scanned plurality of backup data files. However, it is envisaged that in other examples, it may be possible to identify malware files (or susceptible files) using the filename on it's own. Furthermore, it is envisaged that in other examples it may be possible to identify malware files (or susceptible files) using file hashes (e.g., SHA1 or MD5). Thus, hereafter, a reference to comparing a source file path with a scanned plurality of backup data files may include all such options to identify malware files.

In a first aspect of the invention, a method for detection of malware installed on an iOS™ device comprises: identifying at least one known malware signature that is indicative of malware being installed on the iOS™ device; obtaining a backup of the iOS™ device that contains a plurality of data files; scanning the plurality of data files of the backup of the iOS™ device; comparing the scanned plurality of backup data files with at least one known malware signature that is indicative of malware being installed on the iOS™ device; and identifying malware as being installed on the iOS™ device, in response to a match of a scanned backup data file with the at least one known malware signature. In this manner, a mechanism is provided that is able to detect malware on iOS™ devices, which is currently not possible by an iOS™ security application installed on the actual iOS™ device. This is because on devices running the iOS™ operating system, software applications are sandboxed and therefore cannot access areas of the device's file system outside of the application's own ‘container’. Examples of the invention may achieve this by obtaining a backup of the data files of the iOS™ device and compare the data files with predetermined key files that have been determined as being indicators of malware or could contain indicators of malware, when malware has been installed on the iOS™ device.

In some examples, identifying at least one known malware signature that is indicative of malware being installed on the iOS™ device comprises: infecting a ‘clean’ IOS™ device with a known malware; subsequently analysing at least a plurality of data files of the now ‘infected’ iOS™ device to identify changes in those files due to the infection of the known malware; and creating the at least one known malware signature in response thereto. In this manner, the effect of various malware infections can be replicated and these effects may be used to determine whether other iOS™ devices have been similarly infected. In some examples, it is envisaged that this activity may be performed by a malware analysis engine.

In some examples, comparing the scanned plurality of backup data files may include comparing a source file path, which in some examples may include a path and a filename (for example: “C:/Users/Bob/Desktop/document.pdf” would be an example of a source file path), of the scanned plurality of backup data files with stored source file paths from a stored list of key files that have been identified as being susceptible to malware. In this manner, comparing the source file path with a stored list of key files may allow the scan to be more accurate and focused as only files that have been previously shown to be susceptible to malware are searched. This also reduces the chance of false positives. For an oversimplified example of false positives, let us consider a search for malware ‘BADVIRUS’ everywhere within the iOS backup. The search may find a hit that's innocuous and does not mean that the virus is actually installed in the iOS device, for example the user has searched for the term ‘BADVIRUS’ online and the term is found in the OS device's Internet history. By restricting the files being searched (by source file path) the search will then concentrate on only looking in files that should only contain ‘BADVIRUS’ if it has actually infected the device. Comparing the source file path with at least one of a stored list of key files may also make the scan more efficient, as only files that have been previously shown to be susceptible to malware are searched, making the scan run quicker and require less storage space on the analysis device. For an iOS device user, there is also a privacy benefit as the process will only interrogate certain key files and not all files in the iOS backup, for example private photos, messages etc., will not be accessed or read during a scan.

In some examples, a presence of the source file path, which in some examples may include a path and a filename, in the compared backup data file may identify in itself that malware is installed on the iOS™ device. In this manner, no further scanning of the file is needed to confirm that malware exists on the iOS™ device. In some examples, in response to a match from comparing those backup data files that contain the source file path with at least one key file, the method may further include scanning those backup data files to identify at least one malware signature that indicates malware as being installed on the iOS™ device. In this manner, the list of key files may not be exhaustive and a preferred list may be used, for example to support key files being updated or in accordance with new versions of iOS™ or new malware.

In some examples, scanning those backup data files to identify at least one malware signature may include comparing data content of those backup data files with data content contained in a malware threat database. In this manner, some benefits of using a malware signature feature/threat database may include that key files can be easily searched for known threats. Furthermore, in this manner, having a separate threat database, and not having malware signatures hard coded in software, makes it much easier to update when new threats are found. Furthermore, in this manner, a threat database is an efficient way to store details of threats. In some examples, the threat database may be normalized to reduce duplication and therefore the complexity and size of the database.

In this manner, in some examples, the contents of the threat database may not be exhaustive, for example to support updates to the malware threat database to change over time, as new threats are identified.

In some examples, in response to a match from comparing those backup data files that contain the source file path, which in some examples may include a path and a filename, with at least one key file, the method may further include storing those matched backup data files in a storage element for subsequent analysis of whether they contain at least one malware signature. In this manner, an initial parsing of susceptible files from many other non-susceptible files can be performed first, thereby allowing a more focused, subsequent, analysis of the susceptible files when using a threat database.

In some examples, obtaining a backup of the iOS™ device that contains a plurality of data files may include one of: accessing the iOS™ device and creating a local backup of the data files; running an application on the iOS™ device wherein the application creates a local backup of the data files; instigating a backup procedure of the iOS™ device and creating a local backup of the data files; and accessing a cloud storage that contains the backup of the iOS™ device and creating a local backup of the data files therefrom. In this manner, some examples of the invention are able to facilitate a creation of a backup of the data file contents of the iOS™ device that can then be analysed. In this manner, it is possible to effectively search the areas of an iOS™ device where malware could reside, but where current iOS™ security applications are not capable of making such an analysis or determination. In some examples, in response to comparing the source file path against the stored list of key files that are susceptible to malware, and identifying the compared backup data file as not being susceptible to malware, the method may further include deleting the file from the local backup of the data files. In this manner, the non-susceptible files may be discarded thereby allowing a more focused, subsequent, analysis of the susceptible files when using a threat database.

In some examples, accessing the iOS™ device may include accessing the iOS™ device using a connection from at least one of: WiFi™, Universal Serial Bus (USB) Bluetooth, Ethernet or other proprietary wireless communication technologies. The iOS™ device may include an iOS™ Phone™, or an iOS™/iPadOS™ iPad™, or an iOS™ iPod™ Touch™, etc. In this manner, a number of ways are advantageously provided and supported for obtaining and analysing a backup of a variety of iOS™ devices. In some examples, identifying malware as being installed on the iOS™ device, in response to a match of the at least one of the plurality of scanned backup data files with the at least one known malware signature may include providing an output that malware has been found on the iOS™ device wherein the output may include at least one of: a type of malware identified; details of the iOS™ device; a detected installation date of the malware; metadata related to the malware. In this manner, an identification of when and how the malware could have infected the iOS™ device could be obtained, thereby identifying the source of the malware and/or the user who approved the download of malware.

In a second aspect of the invention, an analysis device for connecting to an iOS™ device and detection of malware in the iOS™ device is described. The analysis device comprises: a storage media coupled to an interface and configured to receive a backup of the iOS™ device that contains a plurality of data files via the interface; a malware analysis engine, operably coupled to the storage media and configured to scan the plurality of data files of the backup of the iOS™ device; a malware threat database operably coupled to the malware analysis engine and configured to store at least one known malware signature that is indicative of malware. The malware analysis engine is configured to: compare the scanned plurality of backup data files with the at least one known malware signature obtained from the malware threat database; and identify malware as being installed on the iOS™ device, in response to a match of the at least one of the plurality of scanned backup data files with the at least one known malware signature.

When all identified files have been searched, the results of the scan may be reported back to the user. In some examples, the user may be informed if any malware has been found and, if so, the type of malware. In some examples, the user may also be provided with any further information that is available following the malware detection, such as malware installation date, the exact location of the identified malware in the file system, the developer, usage statistics (e.g., internet data consumed or processor/battery usage) and other metadata, where available.

A number of examples are described below for detecting malware in an iOS™ device (e.g., an iPhone™) that has been infected with a commercial spyware app. Because the illustrated embodiments of the present invention may, for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

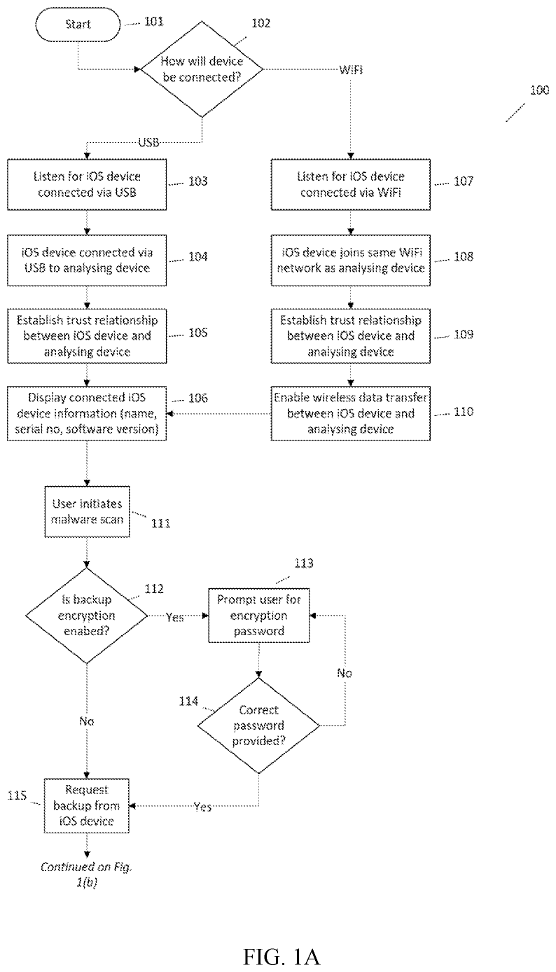

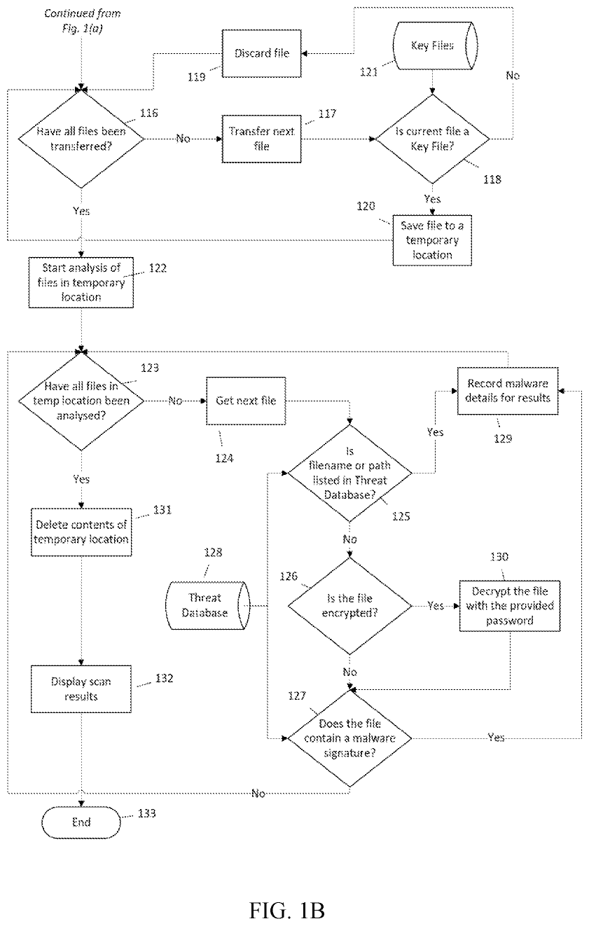

FIG. 1a and FIG. 1b illustrate an example of a flowchart 100 of a method for detection of malware via a backup of the iOS™ device, according to a first example embodiment of the invention. The flowchart 100 starts at 101 and a determination is then made at 102 as to how an analysing device may be connected to an iOS™ device where malware is to be detected. In one example, the iOS™ device is connected to the analysing device via a USB cable, where the analysing device listens for a USB connected iOS™ device at 103, and if an iOS™ device is connected via a USB port at 104, a trust relationship 105 is established between the analysing device and the iOS™ device. Alternatively, in another example, the analysing device determines whether there is a WiFi™ connected iOS™ device at 107, and if an iOS™ device joins the same WiFi™ network as the analysing device at 108, a trust relationship 109 is established between the analysing device and the iOS™ device. At 110, a wireless data transfer between the analysing device (e.g., a computer) and the iOS™ device is enabled, which allows a subsequent transfer (and thereafter reading of device information). In these and/or other examples, it is envisaged that a connection may also be made from at least one of: Bluetooth™, Ethernet or other proprietary wireless communication technologies.

In some examples, an application running on the analysing device, which in some examples is a computer, will detect the connected iOS™ device and the connection details and report the details of the connected iOS™ device back to a user via, say, a user interface.

At 106, following a trust relationship being established between the analysing device and the (iOS™) device using USB or a wireless data transfer between the analysing device and the iOS™ device being enabled over WiFi™, the analysing device may confirm and display details of the connected iOS™ device. In some examples, these reported details may be displayed on the analysing device and may include, the device make, model, serial number and a ‘friendly’/username (e.g., John's iPhone).

In some examples, at 111, the user of the analysing device may initiate a ‘malware scan’ of the iOS™ device. Upon commencing the scan at 111, a determination is made as to whether (or not) backup encryption has been enabled at 112. If backup encryption has been enabled at 112, a user may be prompted for an encryption password at 113 and the process only proceeds if the correct password is provided at 114. At 115, a malware analysis engine in the analysing device may request the backup from the iOS™ device.

At 116, a determination is made as to whether all available backup files have been transferred. In some examples of the invention, the transfer of “all available backup files” encompasses the iOS device sending every file (e.g., one-by-one) associated with a full backup of the iOS device. Note, however, that this is not necessarily every single file from the iOS™ device file system (e.g., it does not include certain operating system files, bootloader, email databases, private application codes, etc.), but instead the files that the iOS™ device provides during a backup in order to facilitate a restore of that iOS™ device. These files contain everything needed to detect malware.

If all backup files have not yet been transferred at 116, the next file is transferred to the analysing device from the iOS™ device at 117. A determination is then made at 118 as to whether the next file transferred is a ‘key’ file. In some examples, this determination is made by accessing a key files storage database at 121 and comparing the records contained therein with the information from the transferred file. In some examples, as each file is transferred to the analysing device, an analysing software application on a signal processor or associated logical firmware or hardware within the analysing device (hereinafter referred to as ‘malware analysis engine’) will compare, say, a source file path, which in some examples may include a path and a filename, against the stored list of key files. In some examples, if the next transferred file is not a ‘key’ file at 118, that next file transferred may be discarded at 119 and the process loops to 116. However, if the next transferred file is a ‘key’ file at 118, the next file transferred is logged as a ‘key’ file and in some examples saved to a temporary location on, say, the analysing device at 120, and the process loops to 116. If a file is listed in the ‘key’ files, then it means that this file may or does contain evidence of malware and should be searched.

If all backup files have been transferred at 116, an analysis of the transferred files that have been selected and stored in a temporary location is made at 122. In essence, each file that has been stored in the temporary location will then searched to determine if:
(i) the presence of the file itself means that malware is present. If so, the type of malware will be noted by the application, to later notify the user; or
(ii) the contents of the file contain certain signatures that are associated with malware, as defined in the Threat Database. If so, the type of malware will be noted by the application, to later notify the user.

In one example, at 123, a determination is made as to whether all of the files in the temporary location have been analysed. If the determination at 123 is that not all of the files in the temporary location have been analysed, then the next file is obtained at 124. A determination is then made at 125 as to whether the file's filename or source file path is listed in the threat database 128. In some examples, this determination is made by accessing the threat database 128 and comparing the records contained therein with the information from the analysed files. If, at 125, the file's filename or source file path is listed in the threat database 128, then a record of the malware details associated with the details from the threat database 128 is made at 129 and the process loops back to 123. If, at 125, the file's filename or source path is not listed in the threat database 128, a determination is made as to whether (or not) the file is encrypted at 126. If the file is encrypted at 126, the file will be decrypted at 130 using the decryption password obtained from the user at step 114.

In some examples of the invention, where the backup data files are encrypted, it is envisaged that all files may be decrypted with the provided password during file transfer, as an additional process during 117. The process would then proceed to 123, but this time all the files in the temp location would be decrypted, so there would be no need for the operations 126 and 130. One advantage of this alternative example is that all files are decrypted at once, rather than one at a time.

At 127, a determination is made as to whether the file contains a malware signature associated with the details from the threat database 128. If the file contains a malware signature at 127, the process loops to 129 where a record of the malware details associated with the details from the threat database 128 is made and the process loops back to 123. If the file does not contain a malware signature at 127, the process loops back to 123.

If the determination at 123 is that all of the files in the temporary location have been analysed, then the contents of the temporary location may be deleted at 131 and the scanned malware results displayed at 132, say via an interface on the analysing device. In this manner, the user will be informed if any malware has been found, and, if so, the type of malware and any further information that is available from the detection, such as malware installation date, the exact location of the malware in the file system, the malware developer, usage statistics (e.g., internet data consumed or processor/battery usage) and other metadata, where available. The process then ends at 133.

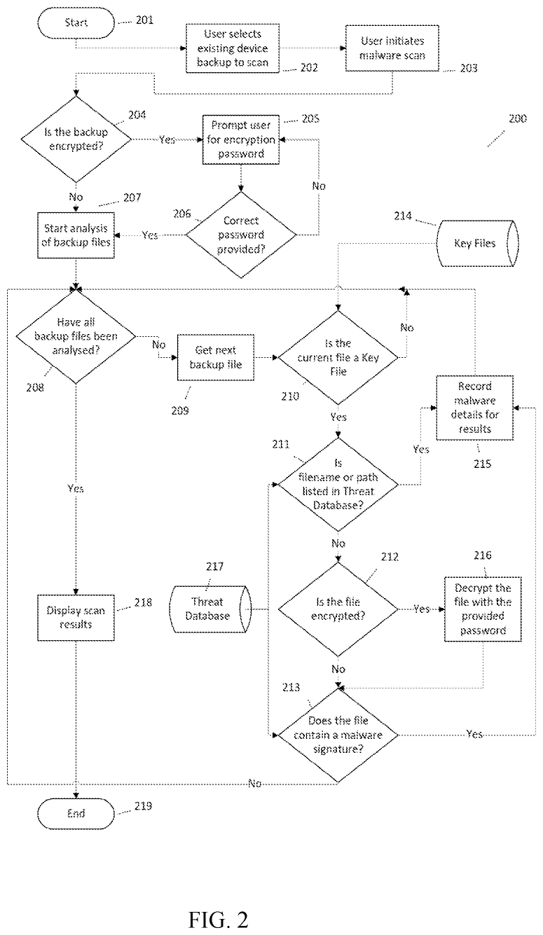

FIG. 2 illustrates a further example of a flowchart 200 of a method for detection of malware via a backup of the iOS™ device, according to a second example embodiment of the invention. It is known that computer software applications for iOS™ devices, such as Apple iTunes™ and other third-party tools have the ability to create a backup of an iOS™ device that may be connectable to a computer, either over a wired (USB) connection or a local wireless (WiFi™) connection. Some of these applications will store the backup data in a folder on the computer or on an external storage device (e.g., a USB drive) connected to the computer. In this further example of the invention, the malware analysis engine located on the analysing device is configured to have the ability to read data from this application-initiated backup in order to determine if malware is present on the iOS™ device.

The flowchart 200 starts at 201. In some examples, within the analysing device, a software application may identify iOS™ backup data stored on the analysing device. In some examples, the malware analysis engine will also extract information from one or each backup stored on the analysing device and report it to the user via say, a user interface, for example: iOS™ device make, model, serial number and friendly name (e.g., John's iPhone). In some examples, the user has an option to ‘scan’ any available device backup(s). Additionally, in some examples, the user may also have an option to set a custom location in which backups may be stored, in the case that backup data exists in a non-default location or on an external storage device (e.g., a USB drive) connected to the analysing device.

A user of the analysing device then selects an existing device backup to scan for malware at 202 and, at 203, the user of the analysing device may initiate a ‘malware scan’ of the iOS™ device backup. Upon commencing the scan at 203, a determination is made as to whether (or not) backup encryption has been enabled at 204. If backup encryption has been enabled at 204, a user may be prompted for an encryption password at 205 and the process only proceeds if the correct password is provided at 206. The analysis of the backup files is started at 207. In some examples, when the user starts the ‘scan’ of a backup, the malware analysis engine may iterate through all files from the backup data and identify any file that's original source file path or filename is listed in key files. A determination is made at 208, as to whether all of the accessed backup files have been analysed. In essence, each accessed file will then be searched to determine if:
(i) the presence of the file itself means that malware is present. If so, the type of malware will be noted by the application, to later notify the user; or
(ii) the contents of the file contain certain signatures that are associated with malware, as defined in the Threat Database. If so, the type of malware will be noted by the application, to later notify the user.

At 209, the next backup file is obtained by the analysing device. A determination is then made at 210 as to whether the next backup file is a ‘key’ file. If a file is listed in the ‘key’ files, then it means that this file may contain evidence of malware and should be searched, if not already providing an indication of malware. In some examples, this determination is made by accessing a key files storage database at 214 and comparing the records contained therein with the information from the backup data. As each file is interrogated by the analysing device, the malware analysis engine will compare, say, the filename or source file path against the list of stored key files. In some examples, if the next backup file is not a ‘key’ file at 210, the process loops to 208. However, if the next backup file is a ‘key’ file at 210, a determination is made at 211 as to whether the filename or source file path of the next backup file is listed in the threat database 217.

In some examples, this determination is made by accessing the threat database 217 and comparing the records contained therein with the information from the analysed files. If, at 211, the filename or source file path is listed in the threat database 217, then a record of the malware details associated with the details from the threat database 217 is made at 215 and the process loops back to 208. If, at 211, the next filename or source file path is not listed in the threat database 217, a determination is made as to whether (or not) the file is encrypted at 212. If the file is encrypted at 212 the file will be decrypted at 216 using the decryption password obtained from the user at step 206. At 213, a determination is made as to whether the file contains a malware signature associated with the details from the threat database 217. If the file contains a malware signature at 213, the process loops to 215 where a record of the malware details associated with the details from the threat database 217 is made and the process loops back to 208. If the file does not contain a malware signature at 213, the process loops back to 208.

If the determination at 208 is that all of the backup files have been analysed, then the scanned malware results may be displayed at 218, say via an interface on the analysing device. In this manner, the user will be informed if any malware has been found, and, if so, the type of malware and any further information that is available from the detection, such as malware installation date, the exact location of the malware in the file system, the malware developer, usage statistics (e.g., internet data consumed or processor/battery usage), and other metadata, where available. The process then ends at 219.

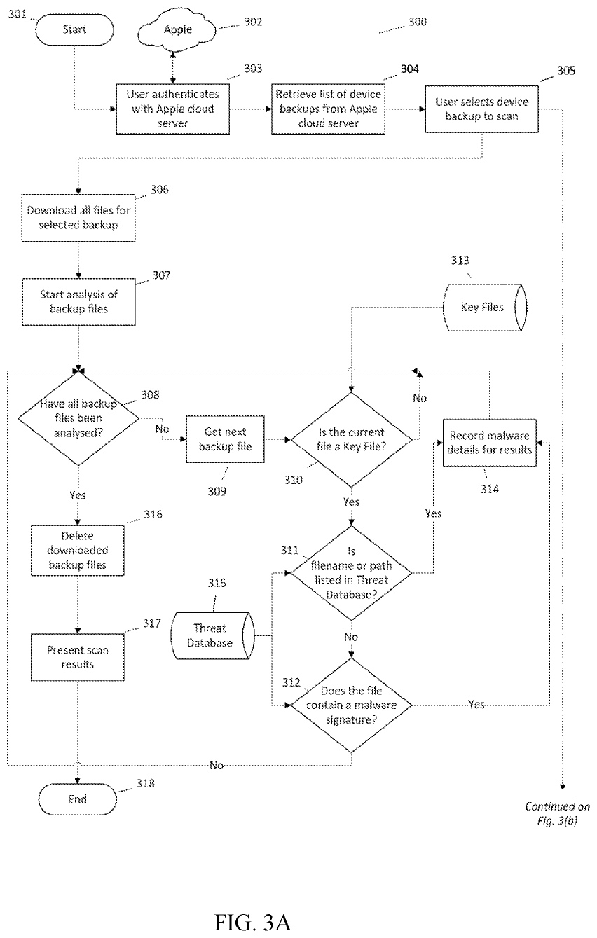

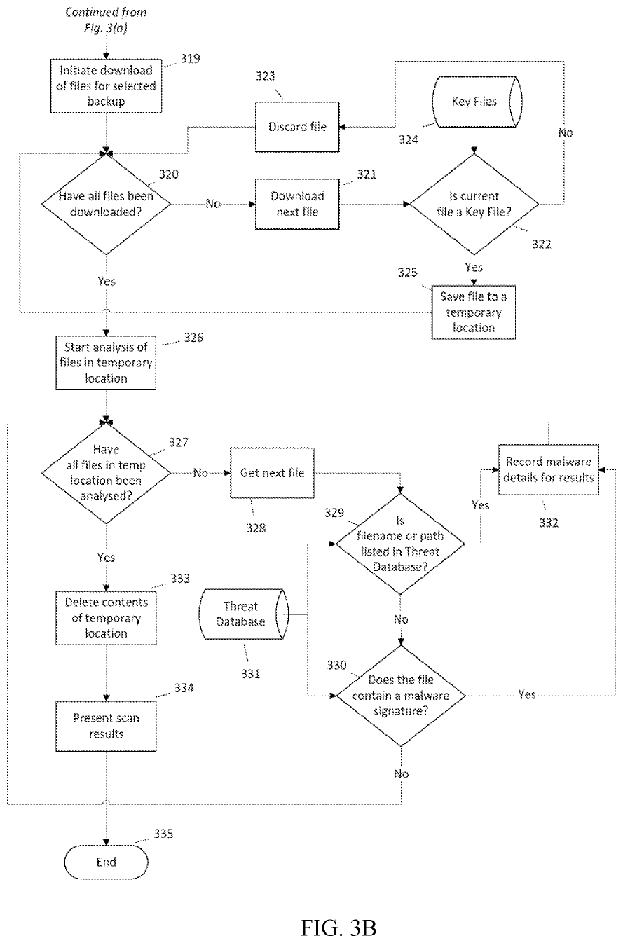

FIG. 3a and FIG. 3b illustrate an example of a flowchart 300 of a yet further method for detection of malware via a backup of the iOS™ device, according to a third example embodiment of the invention. In this example, it is known that owners of iOS™ devices have the option to store a backup of their device on Apple's iCloud™ servers. Thus, in this yet further method for detection of malware via a backup of the iOS™ device, the data stored in a backup of an iOS™ device in iCloud™ can also be used to determine the presence of malware on the iOS™ device itself, by downloading the iCloud™ stored iOS™ data to a local backup data store, e.g., in an analysing device, as described hereinafter.

The flowchart 300 starts at 301 and at 303, the user then authenticates the device with an Apple™ cloud server 302. In some examples, the user will grant access, for the analysing device, to download any iOS™ device data backups stored in, say, iCloud™ by providing the user's Apple ID and password, as well as any other required authentication codes/passwords. At 304, one or more or a list of the iOS™ device's backups is retrieved from the Apple™ cloud server. A download engine in the analysing device connects to the user's iCloud™ account via the Internet and retrieves a list of available device backups. For each backup, in some examples, the download engine in the analysing device may report the device's make, model, serial number, friendly name (e.g., John's iPhone) and backup date/time. The user may also have the option to ‘scan’ any available device backup.

At 305, the user may then select the particular iOS™ device backup for scanning, and the download engine downloads the entire backup (or a selection) of the files and configuration settings for the selected download from Apple™'s iCloud™ servers and stores the downloaded files to a temporary location on, say, the analysing device or a locally connected computer at 306. An analysis of the retrieved selected backup files and configuration settings is performed at 307.

In some examples, the malware may be detectable as a specific setting, e.g., a device configuration setting, in a specific file (as listed in the key files), but where analysing a specific file within the iOS backup does not make use of the threat database in the same manner as previously described. In some examples, when a user starts the ‘scan’ of a backup, the malware analysis engine may iterate through all files of the backup data and identify any file that's original source file path or filename is listed in key files.

As previously mentioned, it is envisaged that in other examples, other indicators of malware, aside from source file path (which may include the filename/path) may include one or more of: iOS device configuration settings, malicious application names, malicious file hashes, keywords associated with malware, etc.

At 308, a determination is made as to whether (or not) all of the backup files have been analysed. In essence, each accessed file will then be searched to determine if:
(i) the presence of the file itself means that malware is present. If so, the type of malware will be noted by the application to later notify the user; or
(ii) the contents of the file contain certain signatures that are associated with malware, as defined in the Threat Database. If so, the type of malware will be noted by the application to later notify the user.

If all of the backup files have not been analysed at 308, then the next backup file is selected for analysis at 309. At 310, a determination is made as to whether (or not) the current analysed file is a (pre-determined) key file. If, at 310, the current analysed file is not a (pre-determined) key file, then the process loops back to 308. However, at 310, if the current analysed file is a (pre-determined) key file, a determination is made at 311 as to whether (or not) the filename or source file path of the current analysed file is listed in the threat database of 315. If the determination made at 311 is that the filename or source file path of the current analysed file is listed in the threat database of 315, the malware details of the current analysed file are recorded at 314 and the process loops back to 308. If the determination made at 311 is that the filename or source file path of the current analysed file is not listed in the threat database of 315, a determination is made at 312 as to whether (or not) the current analysed file contains a malware signature. If the determination made is that the current analysed file does not contain a malware signature, then the process loops back to 308. If the determination made at 312 is that the current analysed file contains a malware signature, then the malware details of the current analysed file are recorded at 314 and the process loops back to 308.

If all of the backup files have been analysed at 308, then in some examples the downloaded backup files may be deleted at 316. The results of the scan may then be presented to the user at 317, or stored for later viewing, and the (main) process ends at 318.

Referring back to 305, where the user selects an iOS™ device's backup to scan, a further optional process can be adopted by moving to 319 where an application in the analysing device initiates a download of files for the selected iOS™ backup. At 320, a determination is made as to whether all backup files have been downloaded. If all backup files have not yet been downloaded at 320, the next file is downloaded to the analysing device from the Apple™ cloud server at 321. A determination is then made at 322 as to whether the next downloaded file is a ‘key’ file. In some examples, this determination is made by accessing a key files storage database at 324 and comparing the records contained therein with the information from the downloaded file. In some examples, as each file is downloaded to the analysing device, a download engine will compare, say, a source file path against the stored list of key files.

In some examples, if the next downloaded file is not a ‘key’ file at 322, that next file downloaded may be discarded at 323 and the process loops to 320. However, if the next downloaded file is a ‘key’ file at 322, the next file downloaded is logged as a ‘key’ file and in some examples saved to a temporary location on, say, the analysing device at 325, and the process loops to 320. If a file is listed in the ‘key’ files then it means that this file may or does contain evidence of malware and should be searched.

If all backup files have been downloaded at 320, an analysis of the downloaded files that have been selected and stored in a temporary location is made at 326. In essence, each file that has been stored in the temporary location will then searched to determine if:
(i) the presence of the file itself means that malware is present. If so, the type of malware will be noted by the application, to later notify the user; or
(ii) the contents of the file contains certain signatures that are associated with malware, as defined in the Threat Database. If so, the type of malware will be noted by the application, to later notify the user.

In one example, at 327, a determination is made as to whether all of the files in the temporary location have been analysed. If the determination at 327 is that not all of the files in the temporary location have been analysed, then the next file is obtained at 328. A determination is then made at 329 as to whether the file's filename or source file path is listed in the threat database 331. In some examples, this determination at 329 is made by accessing the threat database 331 and comparing the records contained therein with the information from the analysed files. If, at 329, the next filename or source file path is listed in the threat database 331, then a record of the malware details associated with the details from the threat database 331 is made at 332 and the process loops back to 327. If, at 329, the next filename or source file path is not listed in the threat database 331, a determination is made as to whether (or not) the file contains a malware signature associated with the details from the threat database 331. If the file contains a malware signature at 330, the process loops to 332 where a record of the malware details associated with the details from the threat database 331 is made and the process loops back to 327. If the file does not contain a malware signature at 330, the process loops back to 327.

If the determination at 327 is that all of the files in the temporary location have been analysed, then the contents of the temporary location may be deleted at 333 and the scanned malware results displayed at 334, say via an interface on the analysing device. In this manner, the user will be informed if any malware has been found, and, if so, the type of malware and any further information that is available from the detection, such as malware installation date, the exact location of the malware in the file system, the malware developer, usage statistics (e.g., internet data consumed or processor/battery usage) and other metadata, where available. The process then ends at 335.

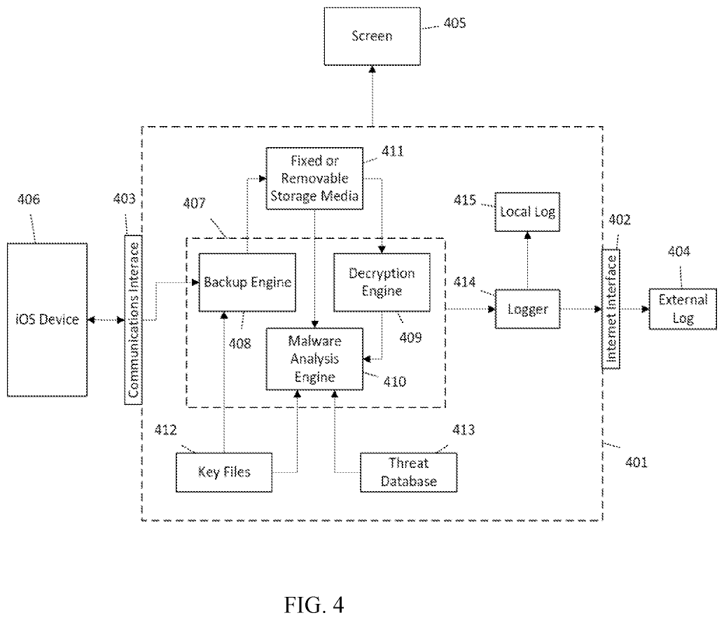

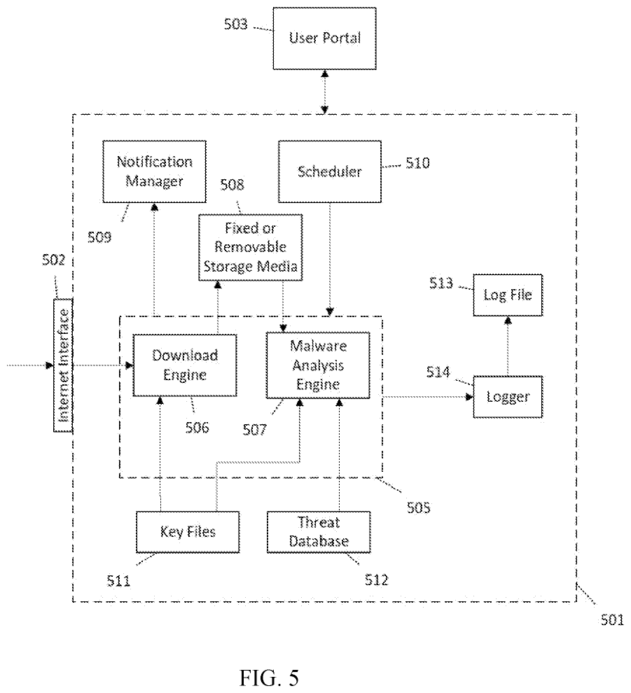

In some examples, it is envisaged that the iOS™ device backup data can either be downloaded to a server or the analysis device described with reference to FIG. 4 or FIG. 5, for analysis by a malware analysis engine, or can be downloaded to a user's computer and analysed there using a software application that can be downloaded and configured to function in accordance with the malware analysis engine of FIG. 4 or FIG. 5. In this latter case, it is envisaged that a user may prefer to download their iOS™ backup data to their own device or computer, in order to assess whether it has been infected with malware, for privacy reasons.

FIG. 4 illustrates a first example system 400 configured to detect malware in an iOS™ device 406 via a backup of the iOS™ device 406, according to the first and/or second example embodiments of the invention. In this first example system 400, an analysis device 401 connects to the iOS™ device 406 and the analysis device 401 is configured to detect malware via a backup of the iOS™ device 406, according to the first and/or second example embodiments of the invention. In this example, the analysis device 401 comprises communication interface 403 for connecting to the iOS™ device 406 and an Internet interface for connecting to a remote external log 404. In this example, the analysis device 401 is also connected to a display screen 405, for displaying any results following a detection of malware.

The analysis device 401 comprises an analysis circuit 407, which in some examples is implemented by firmware, hardware or even software via a DSP, that is connectable to the iOS™ device 406 via the communication interface 403 and configured to detect malware via a backup of the iOS™ device 406. In this example, the analysis circuit 407 comprises a backup engine 408, a decryption engine 409 and a malware analysis engine 410. In this example, the analysis circuit 407 is coupled to a ‘key’ files store 412 configured to provide ‘key’ files data to both the backup engine 408 and the malware analysis engine 410. In this example, the analysis circuit 407 is also coupled to a threat database 413, that contains a list of malware threats and is operably coupled to the malware analysis engine 410. In this example, the analysis circuit 407 is also coupled to a fixed or removable storage media 411, which is configured to receive backup data from the backup engine 408 and provide iOS™ device information and backup data to both the decryption engine 409 and the malware analysis engine 410. In this example, the analysis circuit 407 is also coupled to a logger circuit 414, which is connected to both a local log 415 and the external log 404 via the Internet interface 402. In the context of the present invention, the term ‘engine’ is a core component of a wider complex system, which may include various hardware or firmware components, such as processors, memory, controllers, logic circuits, etc., which may be responsible for performing similar and potentially repetitive tasks. The engine itself may consist of further subcomponents of varying complexity, and respective engines may require different elements to perform their respective tasks, as would be understood by a skilled person in this particular technical field.

In operation, the analysis device 401 detects malware via a backup of the iOS™ device 406, according to a first example embodiment of the invention, where the iOS™ device 406 is connected to the analysis device 401 via a USB cable and establishes a trust relationship there between. Alternatively, the iOS™ device 406 is connected to the analysis device 401 via a WiFi™ connection and establishes a trust relationship there between. In some examples, an application running in the backup engine 410 on the analysis device 401, may report the details of the connected (iOS™) device 401 back to a user via, say, the screen 405.

In addition, in operation, the analysis device 401 is configured to have the ability to read backup data from an application-initiated backup in order to determine if malware is present on the iOS™ device, according to the second example embodiment of the invention. It is known that computer software applications for iOS™ devices, such as Apple™ iTunes™ and other third-party tools have the ability to create a backup of an iOS™ device and the first example system 400 is also configured to analyse backup data stored in this manner.

In some examples the user of the analysing device 401 may initiate a ‘malware scan’ of the iOS™ device 406. Upon commencing the scan, a determination is made by the backup engine 408 as to whether (or not) backup encryption has been enabled. If backup encryption has been enabled, a user may be prompted for an encryption password, stored in the fixed or removable storage media 411 and handled by the decryption engine 409, and the process only proceeds if the password is provided.

A determination is then made as to whether each of the assessed backup files is a ‘key’ file. In some examples, this determination is made by accessing a key files storage database 412 and comparing the records contained therein with the information from the transferred backup data.

In accordance with some examples of the invention the key files list contains a list of, say, filenames or source file paths that may exist in an OS device backup that are of interest for malware detection and need to be analysed when checking an iOS backup for malware. In an example that analyses filenames, each filename will be included in the key files list because it may be one or more of: (i) malware itself, (ii) contain evidence of malware; and/or (iii) contain device settings that can be indicators of malware. In this manner, the key files list is important as it means that only files of interest are retrieved from a backup or only files of interest in an existing backup are analysed, thereby making the process faster and more efficient.

In some examples, the key files storage database 412 may store the key files in encrypted form on the analysing device 401. If a new version of the key files is available, the key files may be downloaded from a remote server (not shown) and overwrite the existing key files on the analysing device 401. Alternatively, it is envisaged that the contents of the key files may be downloaded from a remote server directly into memory whilst the iOS™ device 406 is being analysed by the malware analysis engine 410, and then discarded when analysis is complete.

As each file is transferred to the analysing device 401, a backup engine within the analysis circuit 407 compares, say, a source file path or a filename against the list of key files obtained from the key files storage database 412. In some examples, if the backup file being assessed is not a ‘key’ file, that backup file may be discarded. In some examples, a logger 414, connected to a local log 415, is coupled to the analysis circuit 407. The purpose of the logger 414 and local log 415 is to process and store logs from the analysis circuit 407. These logs may be used for statistical and troubleshooting purposes and would typically include error messages, details of scan results and usage logs, etc. If a file is listed in the ‘key’ files, then it is stored in a temporary location in 411 as it means that this file may contain evidence of malware and should be searched. This decision as to whether the file is a ‘key’ file is made by the backup engine 408 connected to the key files storage database 412.

If all backup files have been assessed, an analysis of the transferred backup files that have been selected and stored in the temporary location in 411 is made. In essence, each file that has been stored in the temporary location in 411 will then be searched to determine if:
(i) the presence of the file itself means that malware is present. If so, the type of malware will be noted by the malware analysis engine 410 to later notify the user; or
(ii) the contents of the file contain certain signatures that are associated with malware, as defined in the Threat Database 413. If so, the type of malware will be noted by the malware analysis engine 410 to later notify the user.

In some examples, the malware analysis engine 410 assesses whether (or not) the filename or source file path of each backup file is listed in the threat database 413 or whether (or not) the file contains malware signatures as listed in the threat database. One purpose of the threat database 413 is to provide a list of indicators of malware to search for when analysing the aforementioned backup files previously identified as key files and stored in the temporary location in 411. In this manner, data from the backup files stored in 411 is compared against the threat database 413 at various times during the analysis, in order to determine whether malware is present, and if so the type of malware. In some examples, the threat database 413 is configured to contain malware signatures, for example in various forms to facilitate different detection techniques. These signatures may include (but are not limited to) one or more of the following: malicious application names, malicious file names, malicious file hashes, keywords associated with malware. For each threat, the threat database 413 may also contain a detailed description of the threat, in order to better inform the user of any threats identified.

In some examples, the threat database 413 may store the malware indicators in encrypted form on the analysing device 401. If a new version of the threat database 413 or malware indicators is available, a new threat database 413 or new malware indicators may be downloaded from a remote server (not shown) and overwrite the existing malware indicators on the analysing device 401. Alternatively, it is envisaged that the contents of the malware indicators be downloaded from a remote server directly into memory whilst the iOS™ device is being analysed by the malware analysis engine 410, and then discarded when analysis is complete.

The scanned malware results may be displayed on screen 405, say via an interface (not shown) on the analysing device 401. In this manner, the user will be informed if any malware has been found, and, if so, the type of malware may also be displayed, as well as any further information that is available from the detection, such as installation date, the exact location in the file system, the developer, usage statistics (e.g., internet data consumed or processor/battery usage), and other metadata, where available.

FIG. 5 illustrates a second example system 500 configured to detect malware via a backup of the iOS™ device, according to the third example embodiment of the invention. In this second example system 500, an analysis device 501 connects to an Apple™ iCloud™ server 504 in order to obtain backup data of an iOS™ device that is to be analysed for malware, according to the third example embodiment of the invention. In this example, the analysis device 501 comprises an Internet interface 502 for connecting to an Apple™ iCloud™ server 504 in order to detect malware via a backup of the iOS™ device. In this example, the analysis device 501 is also connected to a user portal 503, where a user retrieves the results of the scan, e.g., a website they log into or possibly an email report they receive.

The analysis device 501 comprises an analysis circuit 505 that comprises a download engine 506 and a malware analysis engine 507. In this example, the analysis circuit 505 is coupled to a ‘key’ files store 511 configured to provide ‘key’ files data to the download engine 506 and the malware analysis engine 507. In some examples, the ‘key’ files store 511 may store the key files in encrypted form on the analysing device 501. If a new version of the key files is available, the key files may be downloaded from a remote server and overwrite the existing key files on the analysing device 501. Alternatively, it is envisaged that the contents of the key files may be downloaded from a remote server directly into memory whilst the iOS™ device is being analysed by the malware analysis engine 507, and then discarded when analysis is complete.

In this example, the analysis circuit 505 is also coupled to a threat database 512, that contains a list of malware threats and is operably coupled to the malware analysis engine 507. In this example, the analysis circuit 505 is also coupled to a fixed or removable storage media 508, which is configured to receive backup data from the download engine 506 and provide iOS™ device information and backup data to the malware analysis engine 507. In this example, the analysis circuit 505 is also coupled to a logger circuit 514, which is connected to a local log 513, which operates in the same manner as FIG. 4.

In operation, the analysis device 501 detects malware via a backup of the iOS™ device, according to the third example embodiment of the invention. In this regard, an iOS™ device user will grant access, by the analysing device, to any iOS™ device backups stored in, say, iCloud™ by providing the analysing device's download engine 506 with the user's Apple™ ID and password, as well as any other required authentication codes/passwords. In some examples, an application running in the download engine 506 on the analysis device 501, may report the details of the backed-up (iOS™) device to a user via, say, a user portal 503.

The download engine 506 downloads one or more or a list of device's backups from the Apple™ iCloud™ server 504. In this example, download engine 506 in the analysing device connects to the user's iCloud™ account via the Internet and retrieves a list of available device backups. For each backup, in some examples, the download engine 506 in the analysing device 501 may report the device's make, model, serial number, friendly name (e.g., John's iPhone) and backup date/time. The user may also have the option to ‘scan’ any available device backup. In some examples, the user may select the particular device backup for scanning and the download engine 506 downloads the entire backup (or a selection) of the files and configuration settings for the selected download from Apple's iCloud servers 504 and stores the downloaded files to a temporary location on, say, the analysing device 501, for example the fixed or removable storage media 508. An analysis of the retrieved selected backup files and configuration settings is performed. In some examples, when a ‘scan’ of a backup starts, the malware analysis engine 507 may iterate through all files from the backup data and identify any file that's filename or original source file path is listed in key files.

A determination is made as to whether (or not) all of the backup files have been analysed. In essence, each accessed file will then be searched to determine if:
(i) the presence of the file itself means that malware is present. If so, the type of malware will be noted by the application to later notify the user; or
(ii) the contents of the file contain certain signatures that are associated with malware, as defined in the Threat Database 512. If so, the type of malware will be noted by the application to later notify the user.

If the malware analysis engine 507 determines that the current analysed file is a (pre-determined) key file, following a positive comparison with key file data in key file storage 511, a determination is made as to whether (or not) the filename or file source path of the current analysed file is listed in the threat database 512 or whether (or not) the file contains malware signatures as listed in the threat database. In some examples, the threat database 512 may store the malware indicators in encrypted form on the analysing device 501. If a new version of the threat database 512 or malware indicators is available, a new threat database 512 or new malware indicators may be downloaded from a remote server and overwrite the existing malware indicators on the analysing device 501. Alternatively, it is envisaged that the contents of the malware indicators be downloaded from a remote server (not shown) directly into memory whilst the iOS™ device backup is being analysed by the malware analysis engine 507, and then discarded when analysis is complete.

If all of the backup files have been analysed, then in some examples the downloaded backup files may be deleted. The results of the scan may then be presented to the user, or stored for later viewing, via user portal 503.

In some examples, analysing device 501 may also include one or both of a notification manager 509 and scheduler 510. In some examples, notification manager 509 may be used to notify the end user of the results of the scan. For example, this notification may be via a website (e.g., user portal), email, instant message, etc. In some examples, scheduler 510 may be included to manage/schedule automatic scans of an iOS device backup at predetermined times, which may be set by the user. For example, the user may request that the analysing device 501 scans their iOS backup daily at a certain time, and the scheduler 510 will facilitate this.

In some examples, the processor-based ‘engines’ may be implemented using discrete components and circuits in hardware or firmware (for example in a form of logic circuits or logic gates in a field programmable gate array (FPGA)), whereas in other examples the function of the processor-based ‘engines’ may be performed in software using digital signal processors.

Although examples of the invention have been described with reference to detecting malware installed on a user's iOS™ device, such as an Apple™ mobile phone, it is envisaged that in other examples the concepts described herein may be equally applied to a Corporate software product, such that it is configured to automate a detection and reporting of malware on Corporate iOS™ devices, for example if a Corporation used iPad™'s, etc. In some examples of the invention, it is envisaged that the concepts described herein may be employed for law enforcement or legal professionals and litigation support in order to determine if malware is present on an iOS™ device, say, during an investigation. In some examples of the invention, according to the third example embodiment, it is envisaged that the concepts described herein may be employed in a Cloud based service configured to regularly scan backups of iOS™ devices whose data is stored on Apple™'s iCloud™ servers, in order to detect (surreptitiously installed) malware on the iOS™ device.

It is also envisaged that the concepts described herein may beneficially not highlight the fact that an access to the iOS™ device has been made to investigate malware, for example in case it related to an on-going investigation or a Corporate entity did not want the phone user/owner to know. In this context, as there is no need for any software to be installed on the iOS™ device itself in order to perform a scan (as only a backup is analysed), no evidence of the scan exists on the iOS™ device. This may be beneficial if forensic analysis is being performed on the iOS™ device, as the examiner would not want to alter any data on the iOS™ device in order to preserve the evidence Secondly, a victim of malware may not want to alert the ‘hacker’ who installed the malware to the fact that they are checking their device for malware, for example akin to a common use of spyware in detecting surreptitiously whether a domestic abuse situation may be occurring.

A skilled artisan will appreciate that the level of integration of circuits or components may be, in some instances, implementation dependent. Clearly, the various components within the analysis device 401, 501 can be realized in discrete or integrated component form, with an ultimate structure therefore being an application-specific or design selection.

In the foregoing specification, the invention has been described with reference to specific examples of embodiments of the invention. It will, however, be evident that various modifications and changes may be made therein without departing from the scope of the invention as set forth in the appended claims and that the claims are not limited to the specific examples described above. The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals. Those skilled in the art will recognize that the architectures depicted herein are merely exemplary, and that in fact many other architectures can be implemented which achieve the same functionality.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality. Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The circuit and/or component examples may be implemented as any number of separate integrated circuits or separate devices interconnected with each other in a suitable manner. Also, for example, the examples, or portions thereof, may be implemented as soft or code representations of physical circuitry or of logical representations convertible into physical circuitry, such as in a hardware description language of any appropriate type. Also, it is envisaged that embodiments of the invention are not limited to physical devices or units implemented in non-programmable hardware, but can also be applied in programmable devices or units able to analyse an iOS™ backup for malware by operating in accordance with suitable program code. However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

We claim:

1. A method for detection of malware installed on an Internet Operating System (iOS) device, the method comprising:
identifying at least one known malware signature that is indicative of malware being installed on the iOS™ device;
obtaining a backup of the iOS™ device that contains a plurality of data files;
scanning the plurality of data files of the backup of the iOS™ device;
comparing the scanned plurality of backup data files with the at least one known malware signature; and
identifying malware as being installed on the iOS device, in response to a match of the at least one of the plurality of scanned backup data files with the at least one known malware signature.

2. The method for detection of malware of an iOS device of claim 1, wherein identifying at least one known malware signature that is indicative of malware being installed on the iOS™ device comprises:
infecting a clean iOS device with a known malware;
subsequently analysing at least a plurality of data files of the infected iOS™ device to identify changes in those files due to the infection of the known malware; and
creating the at least one known malware signature in response thereto.

3. The method for detection of malware of an iOS device of claim 1, wherein comparing the scanned plurality of backup data files comprises comparing a filename or source file path of the scanned plurality of backup data files with stored filenames or source file paths of a stored list of key files that have been identified as being susceptible to malware.

4. The method for detection of malware of an iOS device of claim 3, wherein scanning those backup data files to identify at least one malware signature comprises comparing data content of those backup data files stored as the list of key files with the at least one malware signature stored in a malware threat database.

5. The method for detection of malware of an iOS device of claim 4, wherein scanning those backup data files to identify at least one malware signature comprises scanning for predetermined key files and scanning each identified predetermined key file for at least one malware signature that has been listed in the malware threat database.

6. The method for detection of malware of an iOS device of claim 3, wherein a presence of the filename or source file path in the compared backup data file identifies in itself that malware is installed on the iOS device.

7. The method for detection of malware of an iOS device of claim 3, wherein in response to a match from comparing those backup data files that comprise the filename or source file path with at least one key file, the method further comprises storing those matched backup data files in a storage element for subsequent analysis of whether they contain at least one malware signature.

8. The method for detection of malware of an iOS device of claim 1, wherein identifying at least one known malware signature that is indicative of malware being installed on the iOS device comprises performing at least one of: file hash analysis, line-by-line comparison of modified files, keyword searches, metadata analysis, file path review.

9. The method for detection of malware of an OS device of claim 1, wherein identifying malware comprises identifying one or more of: a predetermined iOS device configuration setting, a device settings file associated with an unofficial application, a malicious application name, a malicious file hash, a keyword associated with malware, a non-standard keyboard installed on the iOS device.

10. The method for detection of malware of an iOS device of claim 3, wherein, in response to comparing the filename or source file path against the stored list of key files that are susceptible to malware and identifying the compared backup data file as not being susceptible to malware, the method further comprises deleting the backup data file from the local backup of the data files.

11. The method for detection of malware of an OS device of claim 1, wherein obtaining a backup of the iOS device that contains the plurality of data files comprises one of:
accessing the iOS device and creating a local backup of the data files;
running an application on the iOS device wherein the application creates a local backup of the data files;
instigating a backup procedure of the iOS device and creating a local backup of the data files;
accessing a cloud storage that contains the backup of the iOS device and creating a local backup of the data files therefrom.

12. The method for detection of malware of an iOS device of claim 11, wherein accessing the iOS™ device comprises accessing the iOS™ device using at least one of: a WiFi™, Universal Serial Bus, Bluetooth™ or Ethernet connection.

13. The method for detection of malware of an iOS device of claim 1, further comprising repeating the operations of scanning, and comparing the scanned plurality of backup data files with a plurality of known malware signature to identify whether the respective known malware signature has infected the iOS™ device.

14. The method for detection of malware of an iOS device of claim 2, further comprising wiping the iOS device clean, prior to the repeating operation for detection of a next respective known malware signature.

15. The method for detection of malware of an iOS device of claim 1, wherein identifying malware as being installed on the iOS device, in response to a match of the at least one of the plurality of scanned backup data files with the at least one known malware signature further comprises providing an output that malware has been found on the iOS device wherein the output comprises at least one of: a type of malware identified; details of the iOS device; a detected installation date of the malware; a location in a file system, a developer of the malware, a developer of an application whose files have been infected by the malware, usage statistics, metadata related to the malware.

16. An analysis device for connecting to an iOS device and detection of malware in the iOS device comprising:
a malware threat database operably coupled to the malware analysis engine and configured to store at least one known malware signature that is indicative of malware;
a storage media coupled to an interface and configured to receive a backup of the iOS device that contains a plurality of data files via the interface;
a malware analysis engine, operably coupled to the storage media and malware threat database, wherein the malware analysis engine is configured to:
scan the plurality of data files of the backup of the iOS device;
compare the scanned plurality of backup data files with the at least one known malware signature in the malware threat database; and
identify malware as being installed on the iOS device, in response to a match of the at least one of the plurality of scanned backup data files with the at least one known malware signature in the malware threat database.

17. The analysis device of claim 16, wherein the malware analysis engine is further configured to:
infect a clean iOS device with a known malware;
subsequently analyse at least a plurality of data files of the infected OS device to identify changes in those files due to the infection of the known malware;
create the at least one known malware signature in response thereto; and
store in the malware threat database the at least one known malware signature that is indicative of malware.

18. The analysis device of claim 16, wherein the malware analysis engine is configured to: compare a filename or source file path of the scanned plurality of backup data files with stored filenames or source file paths of a stored list of key files that have been identified as being susceptible to malware.

19. The analysis device of claim 16, wherein the malware analysis engine is configured, when connected to the iOS device, to perform one of the following:
access the iOS device and create a local backup of the data files;
run an application on the OS device wherein the application creates a local backup of the data files;
instigate a backup procedure of the iOS device and create a local backup of the data files therefrom;
access a cloud storage that contains the backup of the OS device and create a local backup of the data files therefrom.

20. The analysis device of claim 16, wherein the malware analysis engine is further configured, in response to a match of the at least one of the plurality of scanned backup data files with the at least one known malware signature, to provide an output to the interface that malware has been found on the iOS device, wherein the output comprises at least one of: a type of malware identified; details of the iOS device; a detected installation date of the malware; a location in a file system, a developer of the malware, a developer of an application whose files have been infected by the malware, usage statistics, metadata related to the malware.
